(19) United States
(12) Patent Application Publication
(10) Pub. No.: US 2015/0317654 A1
(43) Pub. Date: Nov. 5, 2015

(54) METHOD AND SYSTEM FOR LINKING TRAFFIC DATA TO PURCHASE BEHAVIOR

(71) Applicant: Mastercard International Incorporated, Purchase, NY (US)

(72) Inventors: Kenny UNSER, Fairfield, CT (US); Kent Olof Niklas Berntsson, Rye, NY (US); Jean-Pierre Gerard, Croton-On-Hudson, NY (US)

(73) Assignee: Mastercard International Incorporated, Purchase, NY (US)

(21) Appl. No.: 14/269,627

(22) Filed: May 5, 2014

(51) Int. Cl. G06Q 30/02

(52) U.S. Cl. CPC G06Q 30/0205

(57) ABSTRACT

A method for linking traffic data to transaction data includes: storing a plurality of transaction data entries, each entry including data related to a payment transaction including at least a geographic location associated with the related payment transaction, a transaction time and/or date, and transaction data; receiving traffic data, the traffic data being related to vehicle traffic and including at least a geographic traffic area, a period of time, and one or more traffic characteristics associated with the vehicle traffic; identifying a subset of transaction data entries where each entry in the subset includes a geographic location included in a geographic transaction area corresponding to the geographic traffic area and a transaction time and/or date included in the period of time; and identifying an economic impact of the vehicle traffic based on at least the transaction data included in each of the transaction data entries included in the identified subset.

### FIELD

The present disclosure relates to the linking of traffic data to purchase behavior, specifically the linking of aggregate vehicle traffic data to payment transactions in a corresponding area to identify an economic impact of the vehicle traffic.

### BACKGROUND

Merchants, advertisers, and other entities often find information regarding consumers, their movements, and their habits to be valuable. These entities can use this information when developing marketing plans and advertising, when targeting new consumers, when creating offers or coupons, when selecting a location for a new location or campaign, and more. However, obtaining such information can be exceedingly difficult for merchants and advertisers, specifically smaller businesses.

Some entities have developed methods for identifying consumer traffic. However, such methods often only measure consumer traffic in and out of a particular merchant location, such as by measuring people that pass through the front doors of a storefront. While this information may be valuable, such data does not cover consumers who pass by a location without stopping and browsing, and thus cannot assist merchants in identifying potential new consumers in the area.

In addition, such entities often do not have access to aggregated transaction data for multiple merchants. Instead, these entities may use only the transaction data for a particular merchant. As a result, merchants and advertisers may only obtain and utilize data regarding consumers and their spending at a single, particular location. These merchants and advertisers may thus be at a loss for data regarding potential new consumers, consumers that may prefer other merchants in the area, and various traffic and purchasing trends that they may be able to take advantage of.

Thus, there is a need for a technical solution to linking aggregated traffic data with purchase behavior in order to benefit merchants, advertisers, and other entities as to the economic impact of vehicle traffic in a particular area.

### SUMMARY

The present disclosure provides a description of systems and methods for linking traffic data to transaction data.

A method for linking traffic data to transaction data includes: storing, in a transaction database, a plurality of transaction data entries, wherein each transaction data entry includes data related to a payment transaction including at least a geographic location associated with the related payment transaction, a transaction time and/or date, and transaction data; receiving, by a receiving device, traffic data, wherein the traffic data is related to vehicle traffic and includes at least a geographic traffic area, a period of time, and one or more traffic characteristics associated with the vehicle traffic; identifying, in the transaction database, a subset of transaction data entries where each transaction data entry in the subset includes a geographic location included in a geographic transaction area corresponding to the geographic traffic area and a transaction time and/or date included in the period of time; and identifying, by a processing device, an economic impact of the vehicle traffic based on at least the transaction data included in each of the transaction data entries included in the identified subset.

A system for linking traffic data to transaction data includes a transaction database, a receiving device and a processing device. The transaction database is configured to store a plurality of transaction data entries, wherein each transaction data entry includes data related to a payment transaction including at least a geographic location associated with the related payment transaction, a transaction time and/or date, and transaction data. The receiving device is configured to receive traffic data, wherein the traffic data is related to vehicle traffic and includes at least a geographic traffic area, a period of time, and one or more traffic characteristics associated with the vehicle traffic. The processing device is configured to: identify, in the transaction database, a subset of transaction data entries where each transaction data entry in the subset includes a geographic location included in a geographic transaction area corresponding to the geographic traffic area and a transaction time and/or date included in the period of time; and identify an economic impact of the vehicle traffic based on at least the transaction data included in each of the transaction data entries included in the identified subset.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for the linking of traffic data to transaction data in accordance with exemplary embodiments.

FIG. 2 is a block diagram illustrating the processing server of FIG. 1 for the linking of traffic data to transaction data in accordance with exemplary embodiments.

FIG. 3 is a flow diagram illustrating a process for linking traffic data to transaction data using the system of FIG. 1 in accordance with exemplary embodiments.

FIG. 4 is a flow chart illustrating an exemplary method for linking traffic data to transaction data in accordance with exemplary embodiments.

FIG. 5 is a flow chart illustrating an exemplary method for distributing a linked consumer profile predicting vehicle traffic based on transaction data in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

### System for Linking Traffic Data to Purchase Behavior

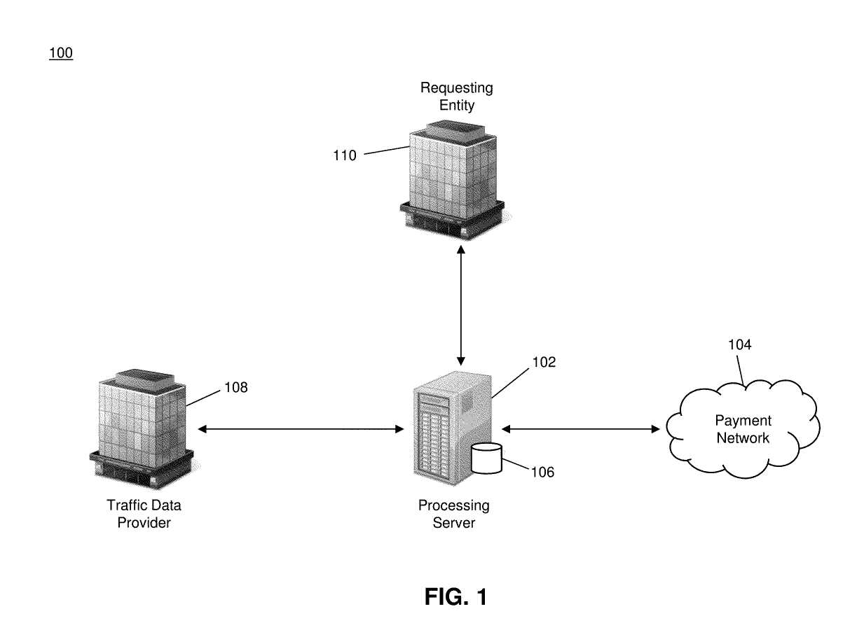

FIG. 1A illustrates a system 100 for linking vehicle traffic data to consumer transaction data.

The system 100 may include a processing server 102. The processing server 102, discussed in more detail below, may be configured to link vehicle traffic data to consumer transaction data. The transaction data may correspond to a plurality of payment transactions, and may be received from a payment network 104. In some embodiments, the processing server 102 may be a part of the payment network 104 and may be further configured to perform additional functions based thereon. For example, the processing server 102 may be further configured to process payment transactions as part of the payment network 104.

The processing server 102 may include a transaction database 106, discussed in more detail below. The transaction database 106 may be configured to store transaction data associated with a plurality of payment transactions. The transaction data may include, for instance, transaction times, transaction dates, transaction amounts, merchant data, product data, consumer data, geographic locations, etc. In some embodiments, the transaction data may be captured during the processing of payment transactions by the processing server 102 and/or the payment network 104.

The system 100 may also include a traffic data provider 108. The traffic data provider 108 may be a system and/or entity configured to identify vehicle traffic data for a geographic traffic area. The vehicle traffic data may include number of vehicles, rates of speed, traffic patterns, frequencies, vehicle behaviors, vehicle types, etc. for the geographic traffic area at one or more periods of time. In some instances, the vehicle traffic data identified by the traffic data provider 108 may be based on multiple periods of time. For example, the vehicle traffic data may include increases or decreases in traffic for the geographic traffic area or a particular location over multiple periods of time. Additional data that may be included in the vehicle traffic data will be apparent to persons having skill in the relevant art.

The processing server 102 may be configured to receive the vehicle traffic data identified by the traffic data provider 108. The processing server 102 may then analyze the vehicle traffic data for the geographic traffic area and transaction data for payment transactions conducted in areas (“geographic transaction areas”) corresponding to the geographic traffic area, to identify an economic impact of the vehicle traffic. In some embodiments, the payment transactions analyzed may be conducted during a period of time to which the traffic data applies. In some instances, the geographic transaction areas corresponding to the geographic traffic area, in which the analyzed payment transactions were conducted, may be encompassed by and/or adjacent to the geographic traffic area. For example, a geographic transaction area may be adjacent and larger than a segment commuter route contained therein, or may a small community of businesses (e.g., gas stations and fast food restaurants) adjacent to an interchange of a larger highway.

In some embodiments, the processing server 102 may identify multiple economic impacts of the vehicle traffic based on transaction data. For example, the processing server 102 may identify consumer propensities to spend across a plurality of product categories, merchants, and/or sub-areas of the geographic traffic area, etc. In another example, the processing server 102 may identify economic impacts of changes in vehicle traffic, such as increased or decreased spending in one or more categories during multiple sub-periods of time.

In some instances, the processing server 102 may identify an economic impact based on a specific merchant or merchants. In such an instance, the processing server 102 may identify transactions involving a specific merchant or merchants, such as a particular merchant or a particular industry (e.g., electronics stores). The processing server 102 may then identify an economic impact of the vehicle traffic with the transaction data for the specific merchant or merchants. As a result, the identified economic impact may be indicative of a correlation between the vehicle traffic and the specific merchant or merchants. For instance, the processing server 102 may identify an increase in traffic due to a merchant opening a new location, or a merchant having increased revenue due to changes in traffic patterns.

In some embodiments, the system 100 may include a requesting entity 110. The requesting entity 110 may be an entity such as a merchant, advertisers, deal provider, etc., that may transmit a request to the processing server 102. The request may be a request for economic impact data, traffic prediction request, or transaction prediction request. The processing server 102 may receive the request and may identify the information requested. For example, if the request is for economic impact data for a particular geographic area and/or period of time, the processing server 102 may identify the economic impact of vehicle traffic for the particular area and/or time based on the transaction data. If the request is for a prediction of vehicle traffic and/or transaction data, the processing server 102 may predict the vehicle traffic and/or transaction data for a particular area and/or time based on previously identified economic impacts and the traffic and/or transaction data available for the particular area and/or time, as discussed in more detail below.

The identification of the economic impact of vehicle traffic for a geographic traffic area based on transaction data for areas corresponding to the geographic traffic area may be beneficial for merchants and other third parties. Such data may be used for merchants to identify target markets, prime locations for advertising or new locations, competitors, potential partners, and more. Advertisers may also find the data useful for identifying locations for advertising and identification of consumers for advertising. Additional benefits by the methods and systems discussed herein will be apparent to persons having skill in the relevant art.

### Processing Server

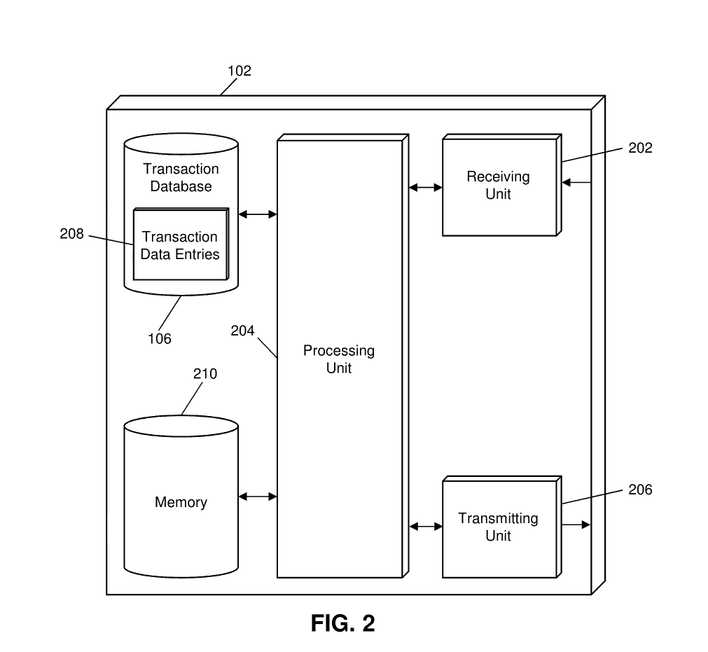

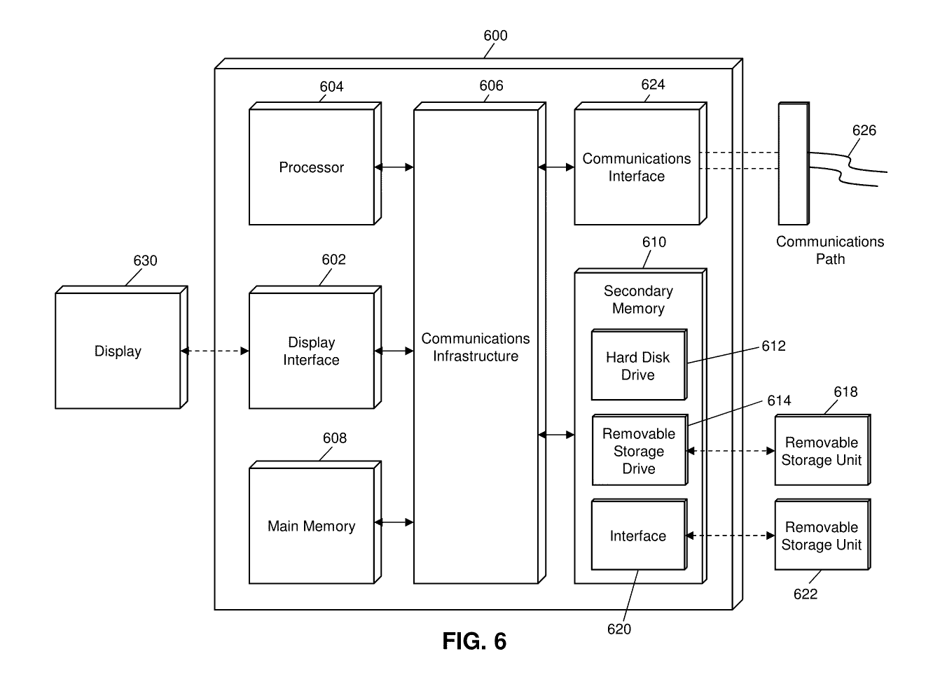

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 600 illustrated in FIG. 6 and discussed in more detail below may be a suitable configuration of the processing server 102.

The processing server 102 may include a receiving unit 202. The receiving unit 202 may be configured to receive data over one or more networks via one or more network protocols. The receiving unit 202 may receive transaction data from the payment network 104 for a plurality of payment transactions. The processing server 102 may also include a processing unit 204. The processing unit 204 may be configured to perform the functions as disclosed herein. As part of these functions, the processing unit 204 may be configured to store the received transaction data in the transaction database 106 as a plurality of transaction data entries 208.

Each transaction data entry 208 may be store data related to a payment transaction and may include at least a geographic location associated with the related payment transaction, a transaction time and/or date, and additional transaction data. The additional transaction data may include transaction amount, merchant data, product data, consumer data, etc. The geographic location may be a physical location associated with the related payment transaction, represented by coordinates, a street address, zip code, postal code, or any other suitable manner as will be apparent to persons having skill in the relevant art. The transaction time and/or date may be a time and/or date at which the payment transaction was completed (e.g., approved, processed, cleared, settled, etc.).

The receiving unit 202 may be further configured to receive traffic data from the traffic data provider 108. The received traffic data may be related to vehicle traffic and may include at least a geographic traffic area, a period of time, and one or more traffic characteristics associated with the vehicle traffic. The traffic characteristics may include, for example, number of vehicles, rates of speed, traffic patterns, frequencies, vehicle behaviors, vehicle types, etc. for the geographic traffic area at one or more periods of time, and other additional characteristics that will be apparent to persons having skill in the relevant art. The geographic traffic area may be an area to which the traffic characteristics may apply, and may be represented by coordinates, a list of postal codes or zip codes, street address, or other suitable methods.

The processing unit 204 may be figured to identify transaction data entries 208 in the transaction database 106 based on the received traffic data. The identified transaction data entries 208 may include transaction data entries 208 where the included geographic location is included in an area corresponding to (e.g., adjacent to, nearby, encompassed by, etc.) the geographic traffic area, and where the included transaction time and/or date is included in the period of time. The processing unit 204 may then identify an economic impact of the vehicle traffic based on the transaction data included in each of the identified transaction data entries 208.

The receiving unit 202 may also be configured to receive a traffic prediction request. The traffic prediction request may include a requested geographic traffic area and a requested period of time. The processing unit 204 may be configured to predict vehicle traffic for the requested geographic traffic area at the requested period of time based on a comparison of the requested geographic traffic area and the geographic traffic area included in the received traffic data, and the requested period of time with the period of time included in the received traffic data. In some embodiments, the predicted vehicle traffic may be further based on transaction data. In such an embodiment, the processing unit 204 may first identify transaction data entries 208 included in the transaction database 106 conducted in areas corresponding to the requested geographic traffic area during the requested period of time. The predicted vehicle traffic may include one or more characteristics, which may be based on the traffic characteristics included in the received traffic data.

The processing server 102 may further include a transmitting unit 206. The transmitting unit 206 may be configured to transmit data over one or more networks via one or more network protocols. The transmitting unit 206 may transmit the predicted vehicle traffic to the requesting entity 110 in response to the received traffic prediction request.

The processing unit 204 may also be configured to predict transaction data. In such an embodiment, the receiving unit 202 may receive a transaction data prediction request. The request may include a requested geographic area and a requested period of time. The processing unit 204 may predict the transaction data for the requested geographic area and period of time based on the identified economic impact for the geographic traffic area and period of time and correspondence between the two areas and times. The transmitting unit 206 may be configured to transmit the predicted transaction data in response to the received transaction data prediction request.

The processing server 102 may also include a memory 210. The memory 210 may be configured to store data suitable for performing the functions disclosed herein. For example, the memory 210 may store rules and algorithms suitable for the prediction of traffic by the processing unit 204 or for the calculation and/or identification of economic impact of vehicle traffic on an area by the processing unit 204. Additional data that may be stored in the memory 210 will be apparent to persons having skill in the relevant art.

### Process for Linking Traffic Data to Transaction Data

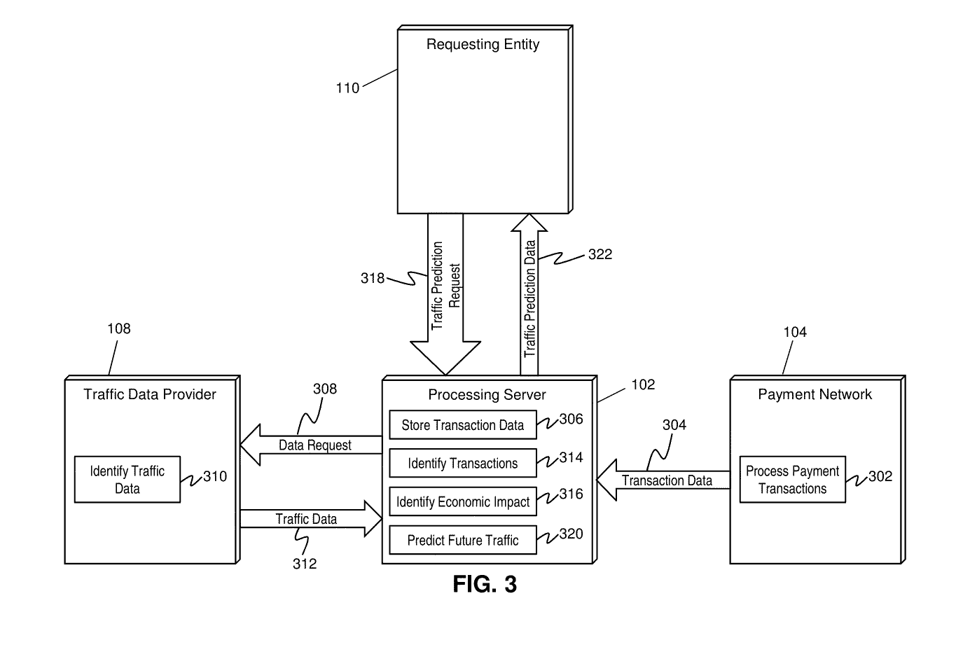

FIG. 3 illustrates a process for the linking of traffic data to transaction data for the identification of an economic impact based on vehicle traffic.

In step 302, the payment network 104 may process a plurality of payment transactions using methods and systems that will be apparent to persons having skill in the relevant art. In step 304, the payment network 104 may transmit transaction data for the processed payment transactions to the processing server 102. The receiving unit 202 of the processing server 102 may receive the data and, in step 306, the processing unit 204 may store the data as a plurality of transaction data entries 208 in the transaction database 106. Each stored transaction data entry 208 may include at least a geographic location, a transaction time and/or date, and transaction data.

In step 308, the transmitting unit 206 of the processing server 102 may transmit a request for traffic data to the traffic data provider 108. The request for traffic data may include one or more geographic areas and one or more periods of time for which traffic data is requested. In step 310, the traffic data provider 108 may identify traffic data that corresponds to the areas and/or times requested. In step 312, the traffic data provider 108 may transmit the traffic data to the processing server 102, to be received by the receiving unit 202.

In step 314, the processing unit 204 of the processing server 102 may identify a subset of transaction data entries 208 in the transaction database 106 where the included geographic location is located in an area corresponding to the geographic traffic area of the received traffic data, and where the included transaction time and/or date is included in a period of time included in the received traffic data. In step 316, the processing unit 204 may identify an economic impact of the vehicle traffic based on the transaction data included in each of the identified transaction data entries 208.

In step 318, the requesting entity 110 may transmit a traffic prediction request to the processing server 102. The traffic prediction request may include at least a requested geographic area and a requested period of time for which predicted vehicle traffic is requested. The receiving unit 202 may receive the request and, in step 320, the processing unit 204 may predict future traffic. In one embodiment, the prediction of future traffic may be based on correspondence between the requested geographic traffic area and the geographic traffic area of the received traffic data and the requested period of time and the period of time of the received traffic data.

In another embodiment, the prediction of future traffic may be based on transaction data stored in transaction data entries 208 of the transaction database 106 that include geographic locations and transaction times and/or dates that correspond to the requested geographic traffic area and requested period of time. In some embodiments, the predicted future traffic may include one or more traffic characteristics. In a further embodiment, the one or more traffic characteristics may be based on traffic characteristics included in the received traffic data.

Once the future traffic is predicted, then, in step 322, the transmitting unit 206 may transmit the traffic prediction data to the requesting entity 110 in response to the traffic prediction request. It will be apparent to persons having skill in the relevant art that, although steps 318 to 322 illustrate the prediction of traffic for an area and time, the processing server 102 may be configured to provide a prediction of transaction data for an area and time using similar steps.

### Exemplary Method for Linking Traffic Data to Transaction Data

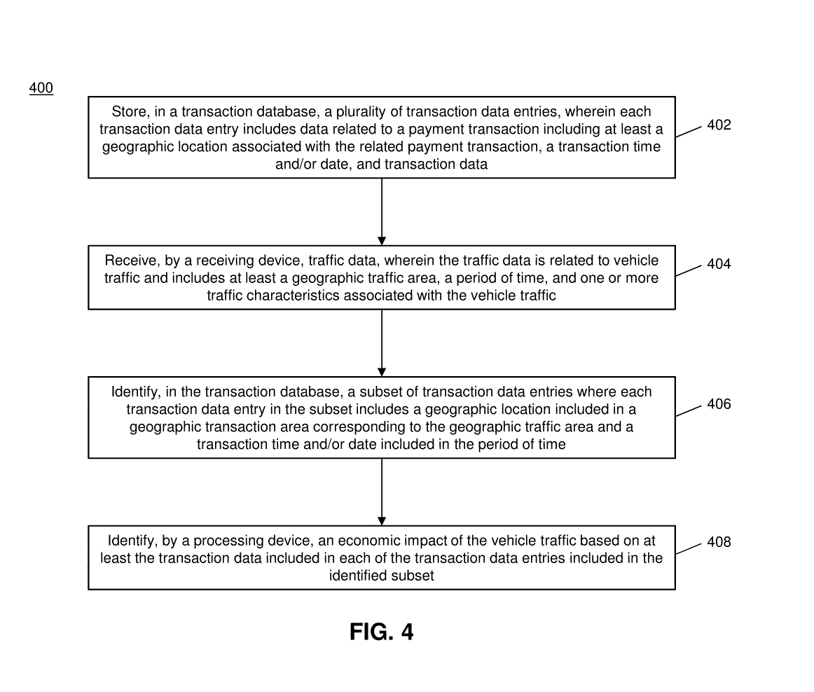

FIG. 4 illustrates a method 400 for linking traffic data to transaction data for the identification of an economic impact for a geographic transaction area and a period of time.

In step 402, a plurality of transaction data entries (e.g., transaction data entries 208) may be stored in a transaction database (e.g., the transaction database 106), wherein each transaction data entry 208 includes data related to a payment transaction including at least a geographic location associated with the related payment transaction, a transaction time and/or date, and transaction data. In step 404, traffic data may be received by a receiving device (e.g., the receiving unit 202), wherein the traffic data is related to vehicle traffic and includes at least a geographic traffic area, a period of time, and one or more traffic characteristics associated with the vehicle traffic.

In step 406, a subset of transaction data entries 208 may be identified in the transaction database 106 where each transaction data entry 208 in the subset includes a geographic location included in a geographic transaction area corresponding to the geographic traffic area and a transaction time and/or date included in the period of time. In some embodiments, the geographic transaction area may be adjacent to and/or encompass the requested geographic traffic area.

In step 408, an economic impact of the vehicle traffic may be identified by a processing device (e.g., the processing unit 204) based on at least the transaction data included in each of the transaction data entries included in the identified subset. In one embodiment, each transaction data entry 208 may be related to a payment transaction involving a specific merchant, and the identified economic impact may be representative of a correlation between the vehicle traffic included in the traffic data and the specific merchant. In some embodiments, the method 400 may further include transmitting, by a transmitting device (e.g., the transmitting unit 206), the identified economic impact. In a further embodiment, the received traffic data may be included in a request for traffic data, and the identified economic impact may be transmitted in response to the received request for traffic data.

In one embodiment, the method 400 may further include: receiving, by the receiving unit 202, a traffic prediction request, wherein the traffic prediction request includes at least a requested geographic traffic area and a requested period of time; predicting, by the processing device 204, vehicle traffic for the requested geographic traffic area during the requested period of time based on at least a comparison of the requested geographic traffic area and requested period of time with the geographic traffic area and period of time included in the received traffic data and the identified economic impact; and transmitting, by the transmitting unit 206, the predicted vehicle traffic in response to the received traffic prediction request.

In a further embodiment, the traffic prediction request may further include transaction data, and the predicted vehicle traffic may be further based on a comparison of the transaction data included in the traffic prediction request and the transaction data included in each transaction data entry in the subset. In another further embodiment, the predicted vehicle traffic may include one or more predicted traffic characteristics based on the one or more traffic characteristics included in the received traffic data.

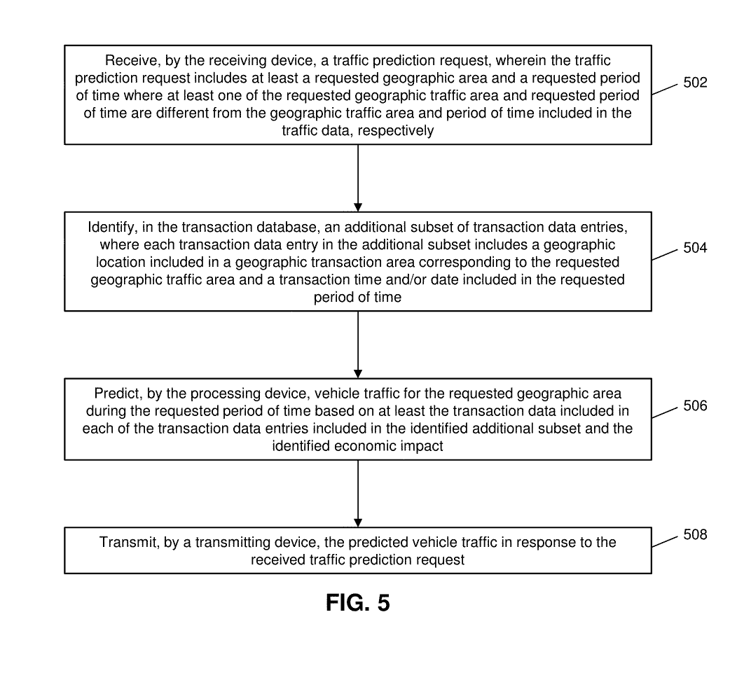

FIG. 5 illustrates a further embodiment of the method 400 for the prediction of traffic based on transaction data and identified economic impact. In step 502, a traffic prediction request may be received by the receiving unit 202, wherein the traffic prediction request includes at least a requested geographic area and a requested period of time where at least one of the requested geographic area and requested period of time are different from the geographic traffic area and period of time included in the traffic data, respectively. In step 504, an additional subset of transaction data entries 208 may be identified in the transaction database 106 where each transaction data entry 208 in the additional subset includes a geographic location included in a geographic transaction area corresponding to the requested geographic traffic area and a transaction time and/or date included in the requested period of time.

In step 506, vehicle traffic for the requested geographic area during the requested period of time may be predicted, by the processing unit 204, based on at least the transaction data included in each of the transaction data entries 208 included in the identified additional subset and the identified economic impact. In one embodiment, the predicted vehicle traffic may include one or more predicted traffic characteristics based on the one or more traffic characteristics included in the received traffic data. In step 508, the predicted vehicle traffic may be transmitted, by the transmitting unit 206, in response to the received traffic prediction request.

### Computer System Architecture

FIG. 6 illustrates a computer system 600 in which embodiments of the present disclosure, or portions thereof, may be implemented as computer-readable code. For example, the processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3-5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for linking traffic data to transaction data. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for linking traffic data to transaction data, comprising:
storing, in a transaction database, a plurality of transaction data entries, wherein each transaction data entry includes data related to a payment transaction including at least a geographic location associated with the related payment transaction, a transaction time and/or date, and transaction data;
receiving, by a receiving device, traffic data, wherein the traffic data is related to vehicle traffic and includes at least a geographic traffic area, a period of time, and one or more traffic characteristics associated with the vehicle traffic;
identifying, in the transaction database, a subset of transaction data entries where each transaction data entry in the subset includes a geographic location included in a geographic transaction area corresponding to the geographic traffic area and a transaction time and/or date included in the period of time; and
identifying, by a processing device, an economic impact of the vehicle traffic based on at least the transaction data included in each of the transaction data entries included in the identified subset.

2. The method of claim 1, further comprising:
receiving, by the receiving device, a traffic prediction request, wherein the traffic prediction request includes at least a requested geographic area and a requested period of time where at least one of the requested geographic traffic area and requested period of time are different from the geographic traffic area and period of time included in the traffic data, respectively;
identifying, in the transaction database, an additional subset of transaction data entries, where each transaction data entry in the additional subset includes a geographic location included in a geographic transaction area corresponding to the requested geographic traffic area and a transaction time and/or date included in the requested period of time;
predicting, by the processing device, vehicle traffic for the requested geographic area during the requested period of time based on at least the transaction data included in each of the transaction data entries included in the identified additional subset and the identified economic impact; and
transmitting, by a transmitting device, the predicted vehicle traffic in response to the received traffic prediction request.

3. The method of claim 2, wherein the predicted vehicle traffic includes one or more predicted traffic characteristics based on the one or more traffic characteristics included in the received traffic data.

4. The method of claim 1, further comprising:
receiving, by the receiving device, a traffic prediction request, wherein the traffic prediction request includes at least a requested geographic traffic area and a requested period of time;
predicting, by the processing device, vehicle traffic for the requested geographic traffic area during the requested period of time based on at least a comparison of the requested geographic traffic area and requested period of time with the geographic traffic area and period of time included in the received traffic data and the identified economic impact; and
transmitting, by a transmitting device, the predicted vehicle traffic in response to the received traffic prediction request.

5. The method of claim 4, wherein
the traffic prediction request further includes transaction data, and
the predicted vehicle traffic is further based on a comparison of the transaction data included in the traffic prediction request and the transaction data included in each transaction data entry in the subset.

6. The method of claim 4, wherein the predicted vehicle traffic includes one or more predicted traffic characteristics based on the one or more traffic characteristics included in the received traffic data.

7. The method of claim 1, further comprising:
transmitting, by a transmitting device, the identified economic impact.

8. The method of claim 7, wherein the received traffic data is included in a request for traffic data, and the identified economic impact is transmitted in response to the received request for traffic data.

9. The method of claim 1, wherein
each transaction data entry is related to a payment transaction involving a specific merchant, and
the identified economic impact is representative of a correlation between the vehicle traffic included in the traffic data and the specific merchant.

10. The method of claim 1, wherein the geographic transaction area is adjacent to and/or encompasses the requested geographic traffic area.

11. A system for linking traffic data to transaction data, comprising:
a transaction database configured to store a plurality of transaction data entries, wherein each transaction data entry includes data related to a payment transaction including at least a geographic location associated with the related payment transaction, a transaction time and/or date, and transaction data;
a receiving device configured to receive traffic data, wherein the traffic data is related to vehicle traffic and includes at least a geographic traffic area, a period of time, and one or more traffic characteristics associated with the vehicle traffic; and
a processing device configured to
identify, in the transaction database, a subset of transaction data entries where each transaction data entry in the subset includes a geographic location included in a geographic transaction area corresponding to the geographic traffic area and a transaction time and/or date included in the period of time, and
identify an economic impact of the vehicle traffic based on at least the transaction data included in each of the transaction data entries included in the identified subset.

12. The system of claim 11, further comprising:
a transmitting device, wherein
the receiving device is further configured to receive a traffic prediction request, wherein the traffic prediction request includes at least a requested geographic area and a requested period of time where at least one of the requested geographic traffic area and requested period of time are different from the geographic traffic area and period of time included in the traffic data, respectively,
the processing device is further configured to
identify, in the transaction database, an additional subset of transaction data entries, where each transaction data entry in the additional subset includes a geographic location included in a geographic transaction area corresponding to the requested geographic traffic area and a transaction time and/or date included in the requested period of time, and
predict vehicle traffic for the requested geographic area during the requested period of time based on at least the transaction data included in each of the transaction data entries included in the identified additional subset and the identified economic impact, and
the transmitting device is configured to the predicted vehicle traffic in response to the received traffic prediction request.

13. The system of claim 12, wherein the predicted vehicle traffic includes one or more predicted traffic characteristics based on the one or more traffic characteristics included in the received traffic data.

14. The system of claim 11, further comprising:
a transmitting device, wherein
the receiving device is further configured to receive a traffic prediction request, wherein the traffic prediction request includes at least a requested geographic traffic area and a requested period of time,
the processing device is further configured to predict vehicle traffic for the requested geographic traffic area during the requested period of time based on at least a comparison of the requested geographic traffic area and requested period of time with the geographic traffic area and period of time included in the received traffic data and the identified economic impact, and
the transmitting device is configured to transmit the predicted vehicle traffic in response to the received traffic prediction request.

15. The system of claim 14, wherein
the traffic prediction request further includes transaction data, and
the predicted vehicle traffic is further based on a comparison of the transaction data included in the traffic prediction request and the transaction data included in each transaction data entry in the subset.

16. The system of claim 14, wherein the predicted vehicle traffic includes one or more predicted traffic characteristics based on the one or more traffic characteristics included in the received traffic data.

17. The system of claim 11, further comprising:
a transmitting device configured to transmit the identified economic impact.

18. The system of claim 17, wherein the received traffic data is included in a request for traffic data, and the identified economic impact is transmitted in response to the received request for traffic data.

19. The system of claim 11, wherein
each transaction data entry is related to a payment transaction involving a specific merchant, and
the identified economic impact is representative of a correlation between the vehicle traffic included in the traffic data and the specific merchant.

20. The system of claim 11, wherein the geographic transaction area is adjacent to and/or encompasses the requested geographic traffic area.
